(19) United States
(12) Patent Application Publication
(10) Pub. No.: US 2006/0030797 A1
(43) Pub. Date: Feb. 9, 2006

(54) Ultrasonic orthopedic surgical device with compound ultrasound vibration

(76) Inventors: Zhaoying Zhou, Beijing (CN); Wenyong Shi, Beijing (CN); Yuli Zhang, Beijing (CN); Xiaoning Luo, Beijing (CN)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 10/932,844

(22) Filed: Sep. 1, 2004

(30) Foreign Application Priority Data
Aug. 3, 2004 (CN) 200410070138.5

(51) Int. Cl. A61H 1/00

(52) U.S. Cl. 601/2

(57) ABSTRACT

An orthopedic surgical device with compound ultrasound vibration that comprises a handpiece, a surgical cutter fixed on the anterior top of the handpiece, and an ultrasound signal generator. Inside the outer casing of said handpiece, there are provided: an ultrasound transducer for transforming the ultrasound signals from said ultrasound signal generator into ultrasound mechanical waves; a horn (or amplitude transformer) for amplifying vibration amplitude of ultrasound mechanical waves generated from said transducer and then transmitting the amplified ultrasound mechanical waves to said surgical cutter to lead to longitudinal vibration of the surgical cutter; a driving motor fixed in the back end of said handpiece for driving said ultrasound transducer and horn to accomplish the movement of swing and rotation; an adapter provided between said driving motor and said transducer for supplying ultrasonic electrical signals generated by said ultrasound signal generator to said ultrasound transducer.

### BACKGROUND OF THE INVENTION

1. Field of the Invention

The invention relates generally to a surgical instrument and, more particularly, to an improved ultrasonic orthopedic surgery system with surgical cutters performing longitudinal and torsional compound ultrasound vibration.

2. Description of the Related Art

With the development of modern medical science, more and more ultrasonic surgical instruments utilizing ultrasound energy for surgery have been widely applied in clinical surgical treatments. The prominent features of ultrasound surgical instruments are precise and safe incision, tissue identification and hemostasis at low temperature, etc. It greatly enriches surgical methods, improves the quality of operations, and decreases the patients' ailment to a great extent. FIG. 1 is a chart showing the principle of a traditional ultrasonic orthopedic surgical device, which comprises a main unit, a handpiece, cutters and a foot switch. The main unit consists of an ultrasound signal generator, a power amplifier and an embedded computer. Low power ultrasonic electrical signals generated by the ultrasound generator are amplified by a power amplifier, then drive the ultrasound transducer inside the handpiece to work. The embedded computer is in charge of harmonizing and controlling the whole system, receiving control orders, showing status of the apparatus, actualizing the function of communication between the operator and machine, foot switch control, and automatic frequency tracking (AFT) of the ultrasound transducer. The handpiece includes an ultrasound transducer and horn, charging to transform ultrasonic electrical signals to ultrasonic mechanical waves, then amplifying vibration amplitude from the horn and transferring mechanical waves to cutters. A cooling fluid irrigation device is attached in the handpiece to lower the cut temperature when the ultrasonic cutters cut bone.

In China Patent No. CN1039780C, an ultrasonic surgical device which comprises a main unit and a handpiece is disclosed. The handpiece comprises transducer, horn, irrigation tube, cables and cutters.

In China Utility Patent No. CN2435054Y, an ultrasonic bone-cutting device is disclosed. The end of the cutting device's horn is connected to a surgical cutter, which adopts a horrent blade structure. During surgeries, the horrent blade cutter driven by the horn performs ultrasonic mechanical vibration in maximum amplitude, from which the cutter generates an excision stress to cut human soft tissue or bone in the surgical region. Forming just a small incision on the patient's skin, this device decreases blood loss and patient's ailment.

Besides, in U.S. Pat. Nos. 5,486,162A, 5,562,609A, 5,562,610A and 6,033,375A, ultrasonic surgical devices performing longitudinal ultrasonic vibration are disclosed. In U.S. Pat. No. 6,497,715A, an ultrasonic device with ultrasonic bone cutters is disclosed to be applied in spine decompression surgeries.

Nevertheless, in existing ultrasonic surgical devices, ultrasonic electrical signals generated by the ultrasonic signals generator drive the ultrasound transducer fixed in the handpiece to transform ultrasonic electrical signals to ultrasonic mechanical waves, of which the amplitude is amplified by the horn and transmitted to the surgical cutter. So, the cutter performs only longitudinal vibration back and forth with low cutting efficiency. This also causes great friction and high temperature between the surgical cutter and the incision, which can increase the incision temperature, even cause heat damage to crucial nerves and blood vessels near the incision.

In addition, the cutter's cross section shape in existing ultrasonic surgical devices usually varies gradually from the thick end fixed in the horn to the slender end performing cutting. So the cutting stress mainly centralizes in the ending region of transition, and leads to fatigue and fracture of the cutter.

### BRIEF SUMMARY OF THE INVENTION

In one aspect, the present invention provides a compound ultrasound vibrational ultrasonic orthopedic surgical device, of which an ultrasound transducer and a mini motor are fixed in the handpiece, thus driving a cutter affixed thereto to perform longitudinal and torsional compound ultrasound vibration and increase the cutting efficiency.

In accordance with another aspect of the present invention, there is provided a compound ultrasound vibrational ultrasonic orthopedic surgical device, of which the ultrasound transducer utilizes intermittent impulsive driving mode, so the accumulation of local heat in the incision region is avoided, and “cold cutting” is actualized.

In accordance with a further aspect of the present invention, there is provided a compound ultrasound vibrational ultrasonic orthopedic surgical device, of which the surgical cutter has multiple transition steps, decentralizing the fatigue stress equably to different parts of the cutter, thus avoiding the cutter fracture caused by centralization of fatigue stress.

Additional objective, advantages and features of the present invention will be set forth in part in the description which follows and, in part, will be obvious from the description to one skilled in the art.

The said and further features of the present invention are actualized through the following technical schemes. There is provided a compound ultrasound vibrational ultrasonic orthopedic surgical device, which comprises a handpiece, a surgical cutter fixed on the anterior top of handpiece and an ultrasound signal generator. Within the outer casing of said handpiece, there are provided: a transducer for transforming ultrasound signals from the ultrasound signal generator into ultrasound mechanical waves; a horn (amplitude transformer) for amplifying vibration amplitude of ultrasound mechanical waves generated from said transducer and then transmitting the amplified ultrasound mechanical waves to said surgical cutter to ensure longitudinal vibration of the surgical cutter; a driving motor fixed in the back end of said handpiece for driving the movements of swing and rotation of said ultrasound transducer and horn; an adapter provided between said driving motor and said transducer for supplying ultrasonic electrical signals generated by said ultrasound signal generator to said transducer.

In said compound ultrasound vibrational ultrasonic orthopedic surgical device, the driving motor fixed in the back end of said outer casing of the handpiece drives the transducer and horn to rotate, so that the surgical cutter fixed on the anterior top of the handpiece performs a longitudinal and torsional compound ultrasound vibration, thus cuts, drills, and mills bone in a surgical region. The surgeon can steadily control the ultrasonic cutter like holding a pen to “carve” the bone with increased cutting efficiency and decreased friction between cutter and incision. The incision temperature is also lowered.

In said orthopedic surgical device, said adapter is a conductive slip ring, which comprises an inside ring and an outside ring electrically connected with said inside ring. Said outside ring is fixed in said outer casing and electrically connected with the signal generator. Said inside ring is electrically connected with said transducer and accomplishes a synchronous rotation with it. Furthermore, the inside ring and outside ring are connected in the manner of an electrical brush.

In accordance with another aspect of the present invention, in said orthopedic surgical device, said ultrasound signal generator transmits impulsive ultrasound signals intermittently to said transducer so that said transducer produces ultrasonic mechanical waves intermittently.

In accordance with a further aspect of the present invention, in said orthopedic surgical device, said surgical cutter has a plurality of transition steps from the thick end to the slender end.

In one embodiment, said surgical cutter include a slice blade with sawteeth.

In another embodiment, said surgical cutter includes a round-headed knife with sawteeth.

In another embodiment, said surgical cutter includes a ball-like or cylinder drill with teeth and grooves.

In another embodiment, said surgical cutter includes a cone-shaped drill with teeth and grooves.

In another embodiment, said surgical cutter includes a glossy ball-like hemostasis knife.

In yet another embodiment, said surgical cutter has a central hollow hole, wherein openings are positioned on the top and the side of the cutter.

In a further embodiment, the present invention provides a method of providing precision cut in an orthopedic surgery using an ultrasonic device, comprising, providing a compound longitudinal and torsional ultrasonic vibration in said ultrasonic device and using the ultrasonic device to perform a surgical technique at a surgical region.

Utilizing the ultrasonic orthopedic surgical device with said structures greatly increases the security and accuracy of operations. The particular structure of the surgical cutter can transmit the centralized ultrasonic energy to the anterior top of the cutter and form great energy density thereon, resulting in an excellent cutting effect. Uniform decentralization of fatigue stress on the cutter increases the useful life of the cutter. In addition, the handpiece held in operator's hand remains still during surgery, which decreases an operator's labor intensity and increases surgical quality. Besides, said ultrasonic orthopedic surgical device protects soft tissue while cutting bone, especially keeping spinal cord from injury in spine surgeries. Furthermore, hemostasis function at low temperature of said ultrasonic orthopedic surgical device causes no cut bleeding, no eschar, and less intercurrent diseases.

### BRIEF DESCRIPTION OF THE DRAWINGS

These and other objects and advantages of the present invention will become apparent and more readily appreciated from the following detailed description of the embodiment, taken in conjunction with the accompanying drawings of which:

FIG. 1 shows the principle of conventional ultrasonic orthopedic surgical devices;

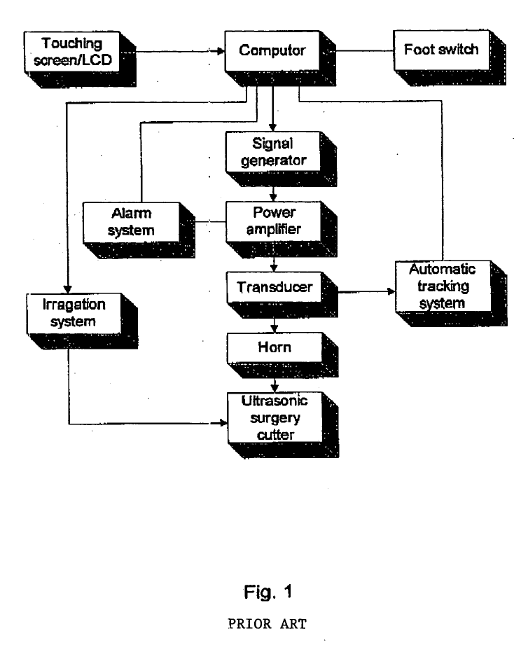

FIG. 2 is a solid view of the handpiece of said compound ultrasound vibrational ultrasonic orthopedic surgical device of the present invention;

FIG. 3 is a longitudinal cross sectional view of the handpiece of FIG. 2;

FIG. 4 is a cross section of the structure of the conductive slip ring in FIG. 3;

FIG. 5 shows a slice blade surgical cutter with sawteeth;

FIG. 6 shows a round-headed surgical cutter with sawteeth;

FIG. 7 shows a cylinder drill with grooves and teeth;

FIG. 8 shows a ball-like drill with grooves and teeth;

FIG. 9 shows a glossy ball-like hemostasis knife; and

FIG. 10 is a cross section of the central hollow structure of the surgical cutter, which is connected with an aspirator pump.

### DETAILED DESCRIPTION OF THE INVENTION

The various embodiments of the present invention are described in details as following, examples of which are shown in the attached drawings, and the like reference numerals refer to the like elements throughout. The embodiments are described below in order to explain the present invention by referring to the figures.

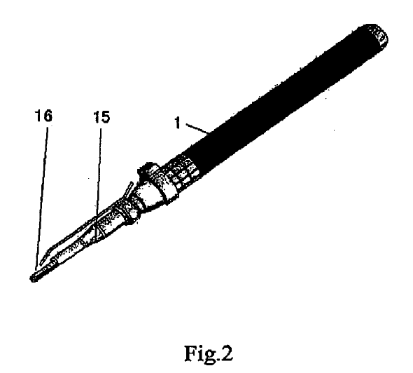

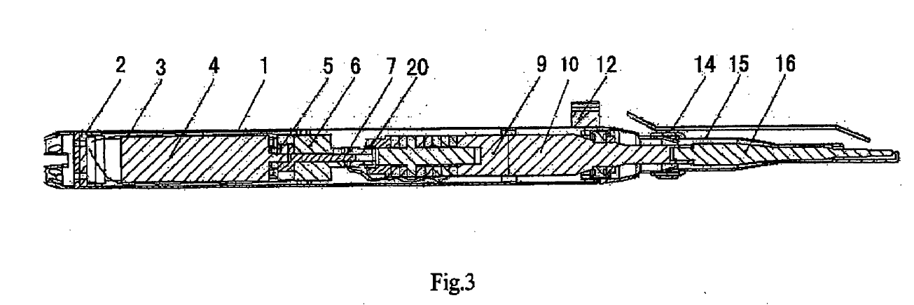

FIG. 2 is a solid view of the handpiece of said compound ultrasound vibrational ultrasonic orthopedic surgical device of the present invention. FIG. 3 is a longitudinal cross sectional view of the handpiece of FIG. 2. As schematically shown in FIG. 2 and FIG. 3, said compound ultrasound vibrational ultrasonic orthopedic surgical device comprises a handpiece 1, a surgical cutter 16 fixed on the anterior top of handpiece 1 and an ultrasound signal generator. Within the outer casing 2 of said handpiece 1, there is provided a transducer 9, a horn (amplitude transformer) 10, a driving motor 4 and an adapter. The transducer 9 transforms ultrasound signals from the ultrasound signal generator into mechanical waves. The horn 10 amplifies the vibration amplitude of mechanical waves generated from transducer 9 and then transmits the amplified ultrasound mechanical waves to surgical cutter 16 to ensure longitudinal vibration of surgical cutter 16. The driving motor 4 is fixed on a bracket 3 provided in back end of outer casing 2, and its exporting axes 5 is connected with the back end of transducer 9 via a coupling 7 to drive the movements of swing and rotation of transducer 9 and horn 10. Also, motor 4 can be connected with transducer 9 and horn 10 via coupling 7 to drive surgical cutter 16 fixed on the anterior top of horn 10 to swing. Preferably, coupling 7 is connected with transducer 9 via an insulator 20 which insulates coupling 7 and transducer 9. Said adapter fixed between motor 4 and transducer 9 supplies ultrasonic electrical signals generated by said ultrasound signal generator to said ultrasound transducer 9. Preferably, the adapter is a conductive slip ring 6, or other device that can supply electricity from fixed cables to rotating components, such as structure of the electrical brush in electromotor or engine. Furthermore, outside the anterior top of outer casing 2, there is provided an affusion bracket 12 for upholding an affusion tube 14 to lower the temperature of surgical cutter 16. Outside the thicker portion of the surgical cutter 16 a protective sleeve 15 is affixed.

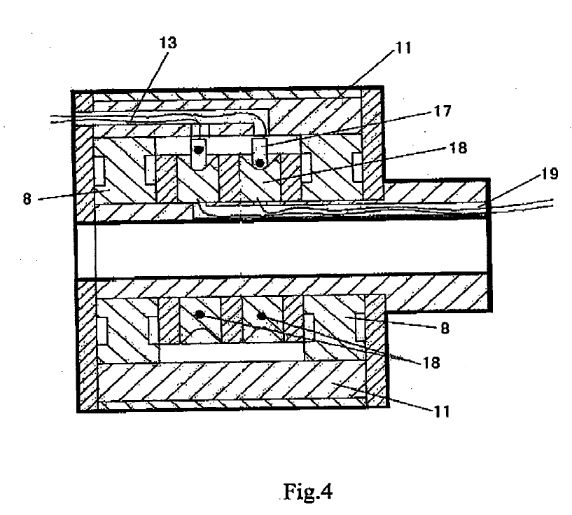

With reference to FIG. 4, in said orthopedic surgical device, the conductive slip ring 6 comprises an inside ring 8 and an outside ring 11 electrically connected with inside ring 8. More specifically, the outside ring 11 fixed in outer casing 2 has a conductive groove 13. The outer signal generator is connected with conductive brush 17 fixed on outside ring 11 via the leads inside conductive groove 13.

The inside ring 8 is set to synchronously rotate with transducer 9. In one example, the driving motor 4 can drive transducer 9 via coupling 7 that passes through the central hole of inside ring 8. The inside ring 8 and coupling 7 are connected and fixed by screw or bond, thus the driving motor 4 can drive the inside ring 8 synchronously to swing or rotate with transducer 9, so the swing of surgical cutter 16 can be actualized by continuous rotation and counter-rotation of transducer 9. A conductor 18 fixed on the inside ring 8 is in the opposite position to conductive brush 17 and realizes a close electrical connection with it. Consequently, when the inside ring 8 rotates, electrical signals from the outer signal generator can be transmitted to conductor 18 that rotates with inside ring 8, and then transmitted to transducer 9 that synchronously rotates with inside ring 8 via the leads inside groove 19, thus ultrasound signals can be transmitted from the ultrasound signal generator to transducer 9. In the structure of said slip ring 6, the inside ring 8 and outside ring 11 are connected by an electrical brush, but the present invention is not limited to this; it can be replaced by other structures which can transmit ultrasound signals from the ultrasound signal generator to transducer 9 that performs swing and rotation.

In handpiece 1 of said compound ultrasound vibrational ultrasonic orthopedic surgical device, the driving motor 4 fixed in outer casing 2 drives transducer 9 and horn 10 to rotate, so the surgical cutter 16 fixed on the anterior top of handpiece 1 performs a compound ultrasound vibration comprising longitudinal vibration, and swings or rotates because of the rotating of motor 4, thus cuts, drills, and mills bone in surgical region. The operator can steadily control the ultrasonic cutter like holding a pen to “carve” the bone with increased cutting efficiency, decreased friction between cutter and incision, and lowered incision temperature accordingly.

Preferably, in said orthopedic surgical device of the present invention, the ultrasound signal generator transmits ultrasound signals intermittently to the transducer 9 to allow the transducer 9 to produces ultrasonic mechanical waves intermittently. Experiments have proved that the cutting temperature in small region of 1-2 mm around the incision is 50-90° C. with cooling irrigation. In the present invention, energy is transmitted from surgical cutter 16 in an instant burst manner. During the interval of ultrasonic power transmitting, accumulation of local heat is avoided by sufficient diffusion of cutting friction heat, thus, “cold cutting” is actualized. The incision temperature below 40° C. prevents the incision, nearby nerves and blood vessels from excessive heat damage.

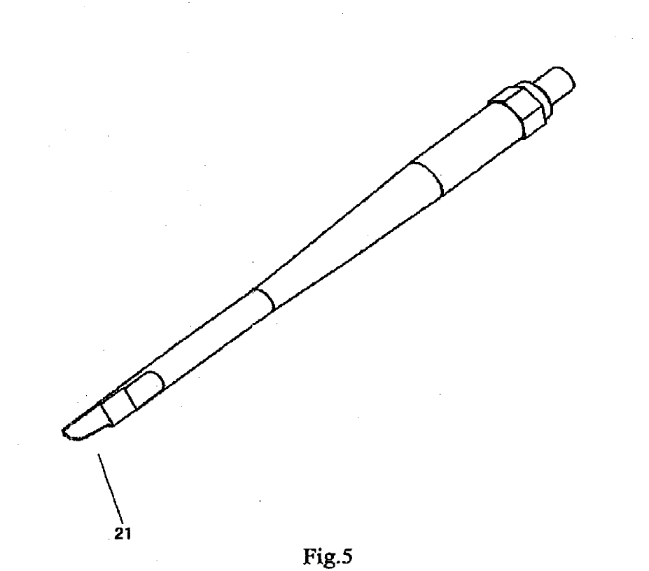

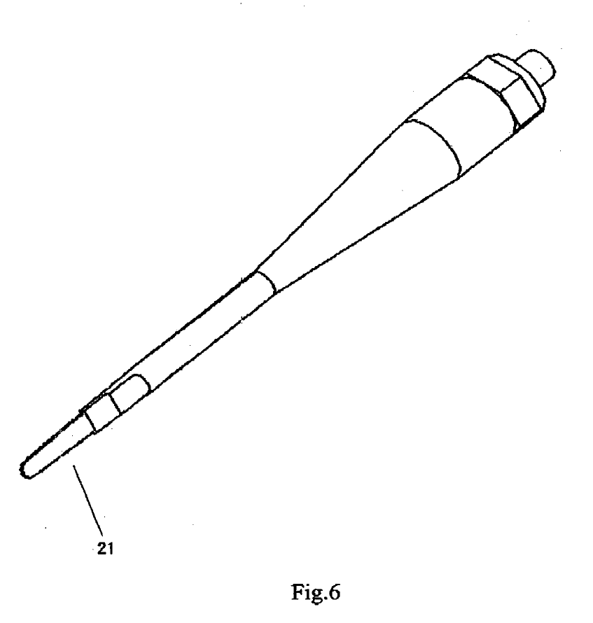

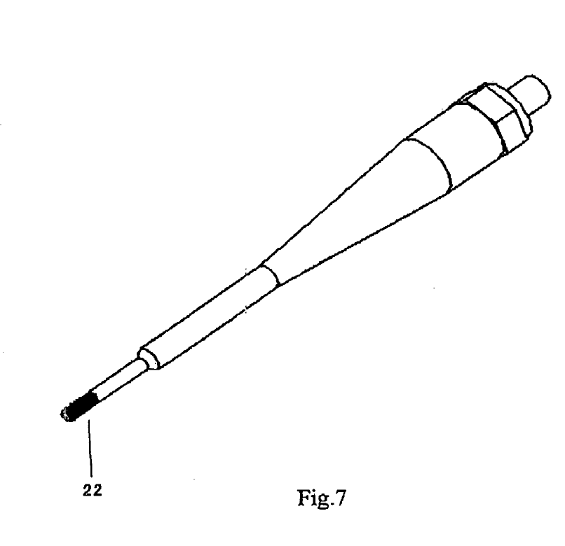

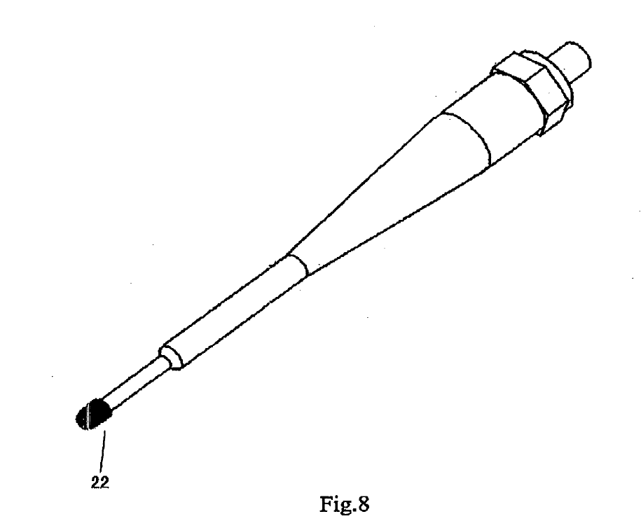

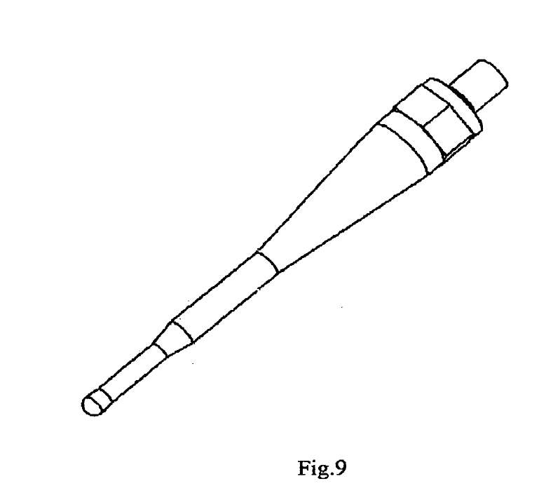

Examples of surgical cutter 16 are schematically shown in FIGS. 5-9. As schematically shown in FIGS. 5-8, surgical cutter 16 has a plurality of transition steps from the thick end to the slender end. It is well known that ultrasonic surgical cutters work at high frequency of 20-60 kHz, easily causing great fatigue and fracturing the cutters. Existing techniques usually make the cutters thicker to avoid fracture, which is impractical for elaborate orthopedic surgeries. So, the surgical cutter has been designed to vary gradually from the thick fixing end to the slender operating end, but the region of transition ending is proved by experiments to be easily fractured because the working stress of the cutter mainly centralizes in this region. The particular structure of surgical cutter 16 of the present invention can transmit the centralized ultrasonic energy to the anterior top of the cutter and forms great energy density there, resulting in an excellent cutting effect. At the same time, uniform decentralization of fatigue stress on the cutter avoids fracture caused by centralization of fatigue stress and increases the useful life of the cutter.

To be adapted with all kinds of clinic orthopedic surgical needs, the surgical cutter 16 of the present invention can be a slice blade or round-headed knife with sawteeth 21 that performs cutting; or a ball-like, cone-shaped or cylinder drill with teeth and grooves that perform drilling, and milling etc, as shown in FIG. 5-8. Furthermore, the surgical cutter 16 can be a glossy ball-like hemostasis knife that actualizes incision hemostasis with no cut bleeding, no eschar, and less intercurrent diseases.

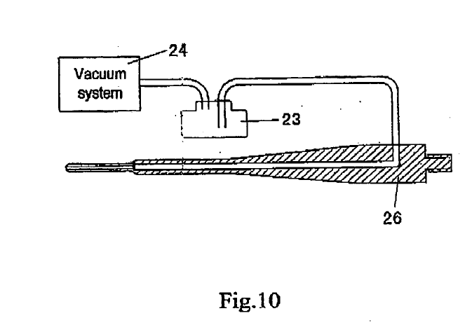

Preferably, referring to FIG. 10, in said orthopedic surgical device of the present invention, said surgical cutter 16 has a central hollow structure, of which openings are positioned on the top and side of the cutter. An aspirator pump comprising a storage chamber 23 and a vacuum system 24 can be connected with the side opening. During surgeries, the aspirator pump draws out bone dregs and other remains to storage chamber 23 utilizing suction of vacuum system 24. This technique clears the operator's visual field and surgical region, avoiding injury of other non-operational tissues like nerves.

In a further embodiment, the present invention provides a method of providing precision cut in an orthopedic surgery using an ultrasonic device, comprising: providing a compound longitudinal and torsional ultrasonic vibration in said ultrasonic device; and using the ultrasonic device to perform a surgical technique at a surgical region.

Furthermore, the method further comprises amplifying the ultrasonic vibration before the step of using the ultrasonic device to perform the surgical technique at the surgical region. Preferably, the surgical technique includes cutting, drilling, sawing and milling bones at the surgical region. More preferably, the ultrasonic vibration is provided intermittently.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

The present invention has been described in terms of certain preferred embodiments, not restrictive ones. Furthermore, the scope of the present invention is not limited by the specific embodiments disclosed herein, but is to be defined and improved by reference to the appended claims and analogous replacements.

1. An orthopedic surgical device with compound ultrasound vibration comprising a handpiece having an outer casing, a surgical cutter fixed on the anterior top of the handpiece, and an ultrasound signal generator, wherein, inside the outer casing of said handpiece, there are provided:
an ultrasound transducer for transforming the ultrasound signals from said ultrasound signal generator into ultrasound mechanical waves;
a horn for amplifying vibration amplitude of the ultrasound mechanical waves generated from said transducer and then transmitting the amplified ultrasound mechanical waves to said surgical cutter to provide longitudinal vibration of the surgical cutter;
a driving motor fixed in the back end of said handpiece for driving said ultrasound transducer and horn to provide the movements of swing and rotation; and
an adapter provided between the said driving motor and said transducer for supplying ultrasonic electrical signals generated by said ultrasound signal generator to said ultrasound transducer.

2. The orthopedic surgical device as described in claim 1, wherein said adapter is a conductive slip ring, which comprises an inside ring and an outside ring electrically connected with said inside ring; said outside ring is fixed in said outer casing and electrically connected with the ultrasound signal generator; said inside ring is electrically connected with said transducer and accomplishes a synchronous rotation with said transducer.

3. The orthopedic surgical device as described in claim 2, wherein said inside ring and outside ring are connected in the manner of an electrical brush.

4. The orthopedic surgical device as described in claim 1, wherein the said ultrasound signal generator transmits impulsive ultrasound signals intermittently to said transducer so that said transducer produces ultrasonic mechanical waves intermittently.

5. The orthopedic surgical device as described in claim 2, wherein said ultrasound signal generator transmits impulsive ultrasound signals intermittently to said transducer so that said transducer produces ultrasonic mechanical waves intermittently.

6. The orthopedic surgical device as described in claim 1, wherein said surgical cutter has a plurality of transition steps from the thick end to the slender end.

7. The orthopedic surgical device as described in claim 2, wherein said surgical cutter has a plurality of transition steps from the thick end to the slender end.

8. The orthopedic surgical device as described in claim 4, wherein said surgical cutter has a plurality of transition steps from the thick end to the slender end.

9. The orthopedic surgical device as described in claim 5, wherein said surgical cutter has a plurality of transition steps from the thick end to the slender end.

10. The orthopedic surgical device as described in claims 1, wherein said surgical cutter includes a slice blade or round-headed knife with sawteeth.

11. The orthopedic surgical device as described in claim 1, wherein said surgical cutter includes a ball-like or cylinder drill with teeth and grooves.

12. The orthopedic surgical device as described in claim 1, wherein said surgical cutter includes a cone-shaped drill with teeth and grooves.

13. The orthopedic surgical device as described in claim 1, wherein said surgical cutter includes a glossy ball-like hemostasis knife.

14. The orthopedic surgical device as described in claim 1, wherein said surgical cutter has a central hollow structure, and wherein openings are positioned on the top end and side of the cutters; said side opening is optionally connected to a vacuum system.

15. A method of providing precision cut in an orthopedic surgery using an ultrasonic device, comprising:
providing a compound longitudinal and torsional ultrasonic vibration in said ultrasonic device; and
using the ultrasonic device to perform a surgical technique at a surgical region.

16. The method of claim 15 further comprising amplifying the ultrasonic vibration before the step of using the ultrasonic device to perform the surgical technique at the surgical region.

17. The method of claim 15 wherein the surgical technique includes cutting, drilling, sawing and milling bones at the surgical region.

18. The method of claim 15 wherein the ultrasonic vibration is provided intermittently.
